(19) United States
(12) Patent Application Publication
(10) Pub. No.: US 2011/0260472 A1
(43) Pub. Date: Oct. 27, 2011

(54) Method for Using Vehicle Movement for Producing Electric Energy

(76) Inventor: Carlos Gomes Barca, Aracatuba (BR)

(21) Appl. No.: 13/127,422

(22) PCT Filed: Oct. 29, 2009
(86) PCT No.: PCT/BR09/00361

§ 371 Date: Jul. 13, 2011

(30) Foreign Application Priority Data
Nov. 3, 2008 (BR) PI 0806126-2

(51) Int. Cl. F03G 7/00

(52) U.S. Cl. 290/1 R

(57) ABSTRACT

The current Patent of Invention intends to produce electrical energy by using the movement (law of inertia) of vehicles in major avenues, streets, roads, highways and similar ones spread in the country and worldwide.

The process of production is basically to implement in highways, roads, avenues and similar ones, large cylinders at the asphalt level—only a part of these cylinders will come into contact with the vehicle tires, and the other part will be inserted inside the passage location vehicle. Through the friction caused among the tires and cylinders, the kinetic energy of the vehicle causes a kinetic energy in the cylinders.

The current demand of Patent of Invention is related to a process for production of energy using the principle of inertia, producing electrical energy through the friction caused among the vehicle tires and cylinders arranged in roads, highways, avenues and similar ones.

Its main application is for the energy industry that produces alternative and renewable energies.

Human societies are increasingly dependent on higher energy consumption for their subsistence. Thus, several processes of production, transportation and storage of energy were being developed throughout the history.

Related to the state of the technique of the innovative process that will be described here, the main forms of production of energy are: hydraulic, nuclear, wind, solar and geothermal.

The hydraulic energy, or water energy, is the energy obtained from the potential energy of a body of water. Its natural way are watercourses, such as rivers and lakes, and can be captured through a gap or waterfall. It can be converted into mechanical energy (rotation of an axis) through hydraulic turbines or water wheels. The turbines, in turn, can be used as a driver for industrial equipment, such as a compressor or an electric generator, in order to provide electrical power to a power network.

The wind energy is used to move large blades of wind turbines to produce electricity: the blades transform mechanical energy into electrical energy. Large wind turbines are placed in locations with high wind speeds and these turbines are shaped like a windmill. The movement of the windmill produces electrical energy through a generator. The windmills need to be grouped in a wind farm, a concentration of wind turbines, which is necessary to produce energy in a profitable way, but they can be used alone, to feed remote and distant locations from the transmission network. It is also possible to use wind power of low voltage when there are limited requirements of electrical energy.

In the same way that electrical energy is produced through the movement of water, in the case of water power, or blades, in the case of wind power, the current device will also generate energy through a movement, i.e. kinetic energy.

Kinetic energy is the energy that a moving body accumulates due to its speed.

It is calculated as:

$${E}_{c} = \frac{1}{2} \cdot {mv}^{2}$$

where m is the body mass and v is its speed.

This means that the faster an object moves, the greater the level of kinetic energy. Moreover, the more mass the object has, the greater the amount of kinetic energy needed to move it. For something to move, it is necessary to transform any other kind of energy on this. The mechanical machines—cars, lathe, pile drivers or any other motorized machine—transform some kind of energy into kinetic energy.

By this current process, we intend to produce electrical energy using the movement (law of inertia) of vehicles in major avenues, streets, roads, highways and similar ones spread in the country and worldwide.

The process of production is basically to implement in highways, roads, avenues and similar ones, large cylinders—or similar devices—at the asphalt level—only a part of these cylinders will come into contact with the vehicle tires, and the other part will be inserted inside the passage location, Through the friction caused among the tires and cylinders, the kinetic energy of the vehicle causes kinetic energy in the cylinders.

These cylinders, in turn, are linked to turbines located in the basement of sidewalks, or even over them, thus transforming the kinetic energy into electrical energy.

The current technology enables the generation of electrical energy through the movement of the cylinders installed in avenues and similar ones, and uses the friction of the vehicle tires to generate such movement. From this movement, the generators will convert kinetic energy into electrical energy.

Only to provide an illustration and to facilitate the understanding of this technology, a brief description of the attached figures is presented, but these should not be understood as limiting the scope of the current demand of Patent of Invention.

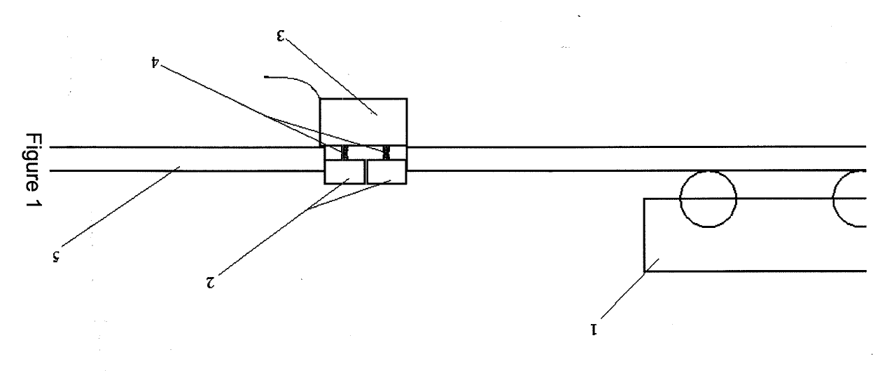

FIG. 1 shows a side view of the mentioned system to capture kinetic energy from the vehicle tires through plates suspended by springs: when the vehicle goes through them the plates will sink generating kinetic energy, which is captured by a conventional generator and converted into electrical energy. In this figure, 1 refers to a particular vehicle, 2 indicates the plates (which can be more than one), 3 refers to a generator, 4 points to springs, and 5 refers to a given road.

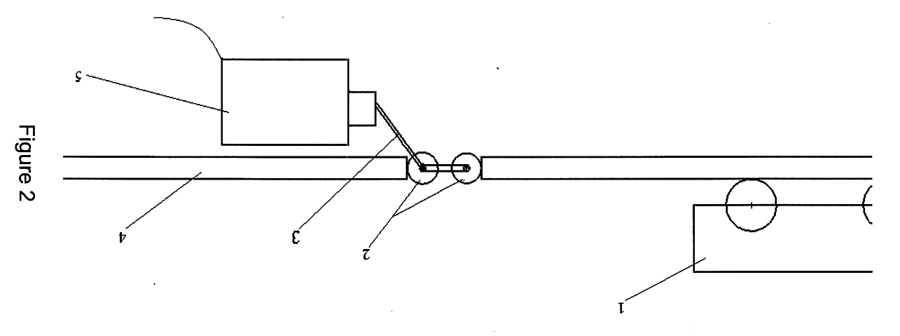

FIG. 2 shows the same mentioned system in this current demand of Patent of Invention. In this model the capture occurs through pulleys (cylinders) that produce kinetic energy when turned, which is sent to a generator to transform it into electrical energy. In this figure, 1 refers to a particular vehicle, 2 points to pulleys, 3 refers to a cardan shaft that will transmit the kinetic energy to a generator, 4 refers to a road, and 5 points to a generator.

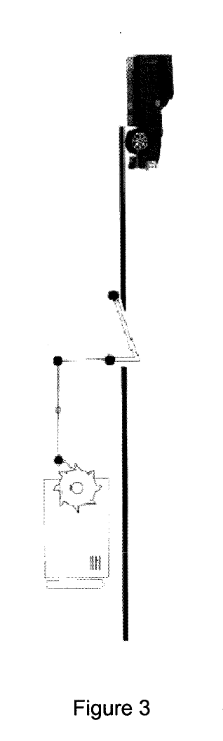

FIG. 3 shows a third way to develop this current technology. In this case, the kinetic energy is captured through small ramps that, when pressed by the vehicle passing over them will lower and spin a gear that will transmit the kinetic energy to a generator.

Considering the foregoing, what is intended to protect with the current invention relates to a process for production of electrical energy using the movement of vehicles in roads, avenues, highways and similar ones.

In order to reach it, major investments are not necessary: it is only necessary to install cylinders in a parallel way to the asphalt surface and link generators to these cylinders to turn kinetic energy into electrical energy.

1. Process for production of electrical energy by using the movement of vehicles, characterized by being basically the implementation of large cylinders at the asphalt level in highways, roads, avenues and similar ones, using only a part of these cylinders that will come into contact with the vehicle tires, and the other part will be inserted inside the passage location; through the friction generated among the tires and the cylinders, the kinetic energy of the tires causes kinetic energy in the cylinder that, in turn, are linked to turbines located in the basement of sidewalks, or even over them, thus transforming the kinetic energy into electrical energy.

2. Process for production of electrical energy by using the movement of vehicles in accordance with claim 1, characterized by this current technology allows producing electrical energy through the movement of cylinders installed in avenues and similar ones, and uses the friction of the vehicle tires to generate this movement that, through generators, is converted into electrical energy.

3. Process for production of electrical energy by using the movement of vehicles in accordance with claim 1, characterized by this current technology produces electrical energy by using as an energy source the movement of vehicles in roads, avenues, highways and similar ones.

4. Process for production of electrical energy by using the movement of vehicles in accordance with claim 1, characterized by being possible to use other devices to capture the kinetic energy, such as plates and small ramps.
